(19) United States
(12) Patent Application Publication
(10) Pub. No.: US 2006/0106129 A1
(43) Pub. Date: May 18, 2006

(54) Optimized alkanolamines for latex paints

(76) Inventors: Michael Gernon, Phoenixville, PA (US); Conor Dowling, Ambler, PA (US); Daniel Alford, Pottstown, PA (US)

Correspondence Address: Steven D. Boyd;Arkema Inc., 2000 Market Street, Philadelphia, PA, 19103, US

(21) Appl. No.: 11/313,052

(22) Filed: Dec. 20, 2005

Related U.S. Application Data
(63) Continuation-in-part of application No. 11/200,224, filed on Aug. 9, 2005.
Application No. 11/200,224 is a continuation of application No. 10/420,448, filed on Apr. 22, 2003, now abandoned.
(60) Provisional application No. 60/378,830, filed on May 8, 2002.

(51) Int. Cl. C09D 5/16

(52) U.S. Cl. 523/122

(57) ABSTRACT

Latex paint formulations that contain N-n-butyl ethanolamine (BAE) as the neutralizing agent and methods for their use are disclosed. BAE provides paint formulations that have low odor, increased open time, and reduced volatile organic compounds (VOC). BAE also aids in pigment dispersion so less pigment dispersant is required for paint formulations in which the pigment volume concentration (PVC) of the formulation is 38% to 80%.

### CROSS-REFERENCE TO RELATED APPLICATIONS

This application is a continuation-in-part of U.S. application Ser. No. 11/200,224 filed Aug. 9, 2005 which is a Continuation of U.S. Application Ser. 10/420,448, filed Apr. 22, 2003, incorporated herein by reference, which claims the benefit of U.S. Provisional Application Ser. No. 60/378,830, filed May 8, 2002.

### FIELD OF THE INVENTION

This invention relates to latex paints. More particularly, the invention relates to latex paints that contain N-n-butyl ethanolamine.

### BACKGROUND OF THE INVENTION

Neutralizing agents are present in latex paint formulations to bring the pH up to an optimal value between 8 and 10, typically about 8.5 to 9.3. For the proper coalescence of the binder polymers in the paint, at least some of the neutralizing agent must evaporate during drying/curing of the paint film, decreasing its pH. Although ammonia and various low molecular weight aliphatic amines have been used in latex paint formulations, they impart an undesirable and unpleasant odor to the paint formulation.

2-Amino-2-methyl-1-propanol (AMP) has also been used as the neutralizing agent in latex paints. Although it has less of an odor problem that other materials that have been used, it still has some odor. In addition, it contributes to the volatile organic compounds (VOC) in the paint formulation. Thus, a need exists for a latex paint formulation that has less odor and a lower VOC.

### SUMMARY OF THE INVENTION

In one aspect, the invention is a latex paint formulation comprising:

a) one of more binders;

b) one or more pigments;

c) water; and

d) N-n-butyl ethanolamine;

in which the pigment volume concentration of the formulation is 38% to 80%.

In another aspect, the invention is a method comprising applying the latex paint formulation to a substrate.

### DETAILED DESCRIPTION OF THE INVENTION

Unless the context indicates otherwise, in the specification and claims, the terms pigment, binder, co-solvent, biocide, surfactant, additive, and similar terms also include mixtures of such materials. Unless otherwise specified, all percentages are percentages by weight.

Latex paint formulations are complex multi-component formulations that are used for the decorative and semi-functional finishing of residential and industrial surfaces. The formulation and manufacture of latex paint formulations is well known to those skilled in the art. Generally, latex paint formulations contain one or more pigments, one or more binders, a liquid carrier, and one or more additives. Additives include, for example, neutralizing agents, leveling agents and surfactants, rheology modifiers, co-solvents, corrosion inhibitors, and biocides.

Neutralizing agents are present in latex paint formulations to bring the pH up to an optimal value between 8 and 10, typically about 8.5 to 9.3. The neutralizing agent may be added to the paint formulation in at least three different places in the manufacturing process: to the pigment dispersion, to the resin dispersion, and/or in a final addition to the paint formulation. At least some of the neutralizing agent evaporates during drying/curing, decreasing the pH of the paint film, which is necessary for the proper coalescence of the binding polymers.

Although ammonia and various low molecular weight aliphatic amines have been used in latex paint formulations, they impart an undesirable unpleasant odor to the paint formulation. 2-Amino-2-methyl-1-propanol (AMP) is commonly used as the neutralizing agent in high end paint formulations were low odor is required. However, it has been found that N-n-butyl ethanolamine (n-C₄H₉—NH—CH₂CH₂OH) (BAE) is superior to AMP as the neutralizing agent for latex paints. BAE has low odor, excellent assistance to pigment dispersion, excellent assistance to water resistance, excellent corrosion inhibition, and excellent leveling and emulsification. Latex paints containing BAE neutralizing agent tested lower in volatile organic compounds (VOC) than those that contained AMP neutralizing agent. BAE increases the open time of the paint formulation. Because co-solvents that are volatile organic compounds are typically added to increase open time, the amount of volatile organic compounds in the paint formulation can be reduced.

BAE provides superior pigment dispersion. This is an advantage for flat paint formulations that have higher PVC's, typically 38% to 80%. In addition, BAE has a physical biocide synergist activity, that is, BAE/biocide mixtures are more effective in controlling microorganisms than AMP/biocide mixtures containing the same amount of neutralizing agent and biocide. This means that the same amount of biocidal activity can be obtained with less biocide when BAE is used as the neutralizing agent. Latex paint formulations based on resins comprising copolymers of acrylate esters, vinyl acetate and/or styrene typically comprise about two to ten pounds of BAE per one hundred gallons of finished latex paint formulation.

Pigments provide the color and hiding value of the paint. In addition, some pigments are added to impart bulk to the paint at relatively low cost. Pigments are finely ground particles or powders that are dispersed in the paint formulation. Pigments are insoluble in the carrier. There are two primary categories of pigments, prime pigments and extender pigments. Prime pigments provide color and are the main source of hiding capability. Titanium dioxide is the predominant white pigment. It provides whiteness by scattering the incident light and by hiding the surface to which the paint is applied. Color pigments provide color by selective absorption of the incident light. Organic pigments include, for example, copper phthalocyanines such as phthalocyanine blue and phthalocyanine green, quinacridone pigments, and Hansa yellow. Inorganic pigments include, for example, carbon black, iron oxide, cobalt blue, brown oxide, ochres, and umbers. The prime pigments are typically used with an extender pigment or pigments. Commonly used extender pigments include clays such as kaolin and china clay; silica, diatomaceous silica, and talc (magnesium silicate); calcium carbonate, such as chalk powder or marble powder; and zinc oxide.

The binder provides the durable and flexible matrix within which the pigments are dispersed and suspended. It binds the pigment particles together and provides integrity and adhesion for the paint film. The binders for latex paints are typically produced by free radical initiated aqueous emulsion polymerization of a monomer mixture containing alkyl acrylate (methyl acrylate, ethyl acrylate, butyl acrylate and/or 2-ethylhexylacrylate), alkyl methacrylate, vinyl alcohol/acetate, styrene, and, to a lesser extent, acrylonitrile and ethylene type monomers. The 100% acrylic resins exhibit better performance, but are generally more expensive. The pure vinyl (polyvinyl alcohol/acetate) resins are cheaper but have poor water resistance. Mixed vinyl-acrylic resins and 100% acrylic resins are most commonly used in North America. Styrene-acrylic resins are commonly used in Europe and in industrial maintenance type paints. The binder is typically dispersed in water as a polymer latex.

Pigment Volume Concentration (PVC) indicates the relative proportion of pigment to binder in the paint formulation. It is a comparison of the volume of the pigment or pigments to the total volume of the binder or binders and the pigment or pigments. To calculate the volume of each ingredient, it is necessary to divide the amount present in the formulation by its density. Pigment Volume Concentration is calculated as follows:
%PVC=[Volume of Pigments/(Volume of Pigments+Volume of binder)]×100

Pigment typically reduces the shininess or gloss of the binder, so, in general, the paint becomes less glossy as PVC increases. Typical PVC values associated with different levels of paint gloss are: gloss, 15% PVC; semigloss, 25% PVC; satin, 35% PVC, eggshell, 35-45% PVC; and flat, 38-80% PVC. Higher quality flat paints, both interior and exterior, generally have PVC's of about 38% to 50%.

The ingredients of the latex paint formulation are dissolved, suspended and/or dispersed in a carrier. Water is the only carrier of importance in latex paints After all the others ingredients of the latex paint formulation have been accounted for, water makes up the balance of the formulation. Deionized water is typically used.

Additives are additional ingredients that are added in small amounts to provide specific properties to the paint formulation and/or the paint film, such as mildew resistance, defoaming, light stability, and/or good flow and leveling during application. In addition to the neutralizing agent, discussed above, other additives that may be present in the paint formulation include some or all of the following types of materials.

Co-solvents are sometimes present in the paint formulation to aid in film formation, to resist freezing, and/or enhance brushing properties, such as by increasing open time. Open time is the time that a coating remains workable after it has been applied to a substrate. Open time allows for rebrushing or “melting in” of the newly applied coating at the lap, without causing brush marks, loss of gloss, or lap lines in the final dried coating. A lap is an area on a substrate where additional coating is applied onto a portion of a previously coated, but still wet, adjacent substrate area. Typically the amount of co-solvent may be 10 to 20 percent or more based on total liquid content of the paint formulation. Typical co-solvents are short chain water-soluble alcohols and glycols, such as ethylene glycol, diethylene glycol, propylene glycol, and glycerin. However, these co-solvents negate some of the advantages of aqueous coatings such as low tack, low odor, and low pollution. Because co-solvents are generally volatile organic compounds, only the minimum amounts necessary are used.

Leveling agents are added to change the surface tension and improve wetting. Leveling agents are a subset of surfactants used to insure that a paint formulation flows out over and completely wets the surface being painted. Reduced contact angles between the paint formulation and the surface lead to better flow leveling, and better surface wetting allows for better adhesion of the wet paint formulation and the dried paint film. Surfactants are also important as grinding aids for pigment grinding operations.

Rheology modifiers are added to thicken the paint formulation and to increase its yield stress, thus allowing for the formation of a stable suspension of pigments in resin upon mixing. Rheology modifiers are also added to optimize the application properties of the paint. Pigment dispersants are added to create a stable dispersion of the pigment. Pigment dispersants function by directly interacting with pigment particles both mechanically and electrostatically. Rheology modifiers function by increasing the yield stress of the water-resin system.

Corrosion inhibitors and flash rust inhibitors, while not essential, are added to a number of latex paints to suppress the migration of colored corrosion products from the surface of painted metal objects (e.g., exposed nail heads in drywall) to the surface of the paint. Also, some paint formulators add rust inhibitors to prevent corrosion of iron alloy paint cans during paint storage.

Biocides and mildewcides are added to control microbial growth in the paint formulation and/or in the paint film. Microbes can colonize latex paints leading to filamentous growths, bad odors and the selective consumption of functional paint ingredients. Some biocides are added solely to control microbes during storage of the paint formulation (so called in-can biocides) while other biocides are added to impart biostability to the dried/cured paint film (so called dry film biocides). Some biocides can prevent both in-can and dry film biological growth. Typical biocides include isothiazolinones, such as 5-chloro-2-methyl-4-isothizolin-3-one; benzoisothiazolinones; triazines, such as hexahydro-1,3,5-tris-2-hydroxyethyl-s-triazine; 1-(3-chloroallyl)-3,5,7-triaza-1-azoniaadamantane chloride (DOWICIL® 75); zinc pyrithione; gluteraldehyde; bronopol; and phenolics.

Defoamers are special types of surfactants that have the effect of decreasing the foaminess of an agitated paint formulation, when it is manufactured, when it is shaken or stirred, and when it is applied to a surface. Defoamers are commercially available under a number of tradenames such as, for example, FOAMASTER®, ADVANTAGE® 1512, and BYK® 1650.

The evaporation of water and other volatile materials from a wet latex paint film begins the coalescing process by which the particles of binder coalesce into a continuous phase or film. However, the coalescence of many latex binders will not occur properly unless a small amount of more slowly evaporating solvent is present. 2,2,4-Trimethyl-1,3-pentanediol monoisobutyrate, (TEXANOL® ester alcohol) and 2-ethylhexyl benzoate (VELATE® 378) are commonly used coalescing agents.

In addition to the additives listed above, the paint formulation may also comprise other additives such as, for example, light stabilizers, heat stabilizers (particularly for baked coatings), cross-linking agents (mostly used with specialty resins containing cross-linkable groups), curing catalysts, mar/slip aids, and flatting agents.

The manufacture of paint formulations is well known to those skilled in the art. In the first phase, known as the grind phase, the dry pigments are dispersed into part of the carrier. The pigment dispersant and some of the other additives are also added during the grind phase. Once the pigment is dispersed, in the second phase, known as the letdown phase, the remaining ingredients, including the binder are added. The physical properties, such as viscosity and pH are checked. There may be a final addition of carrier and/or other ingredients to adjust the properties of the paint formulation. The paint formulation is then packaged and sent to consumers.

### INDUSTRIAL APPLICABILITY

The paint formulations of the invention are useful as latex paints, typically as flat latex paints that can be used in interior and exterior applications. They can be applied to a wide variety of substrates such as, for example, paper, wood, concrete, metal, glass, ceramics, plastics, plaster, and roofing substrates such as asphaltic coatings, roofing felts, foamed polyurethane insulation; or to previously painted, primed, undercoated, worn, or weathered substrates using a variety of techniques well known in the art such as, for example, brush, rollers, mops, air-assisted or airless spray, and electrostatic spray.

The advantageous properties of this invention can be observed by reference to the following examples, which illustrate but do not limit the invention.

### EXAMPLES

### Glossary

ACRYSOL® RM-1020 Nonionic polyurethane associative rheology modifier, 19.0-21.0% total solids (Rohm & Haas, Philadelphia, Pa.)
AMP 2-Amino-2-methyl-1-propanol (Dow, Midland, Mich.)
BAE N-n-butyl ethanolamine (n-C₄H₉—NH—CH₂CH₂OH) (Arkema, Philadelphia, Pa.)
BYK®-156 Pigment dispersant, aqueous solution of an ammonium salt of an acrylate copolymer (BYK Chemie, Wallingford, Conn., USA)
BYK®-1650 Defoamer, blend of siloxylated polyethers and hydrophobic particles (BYK Chemie, Wallingford, Conn., USA)
Colloid 226/35 35% water soluble anionic-pigment dispersant, viscosity stabilizer (Rhodia, Cranbury, N.J.)
Colloid 640 Hydrophobic silica-type defoamer (Rhodia, Cranbury, N.J.)
FOAMASTER® VL Oil-based defoamer (Cognis, Cincinnati, Ohio)
MINEX® 4 White, non-clay, nephylene syenite, specific gravity 2.56 (Unimin Specialty Minerals, New Canaan, Conn.)
Polyphobe 102 Rheology modifier, 25% emulsion of an acrylic polymer in water (Dow, Midland, Mich.)
PROXEL® GXL Preservative containing 9.3% 1,2-benzisothiazolin-3-one (Avecia, Wilmington, Del.)
RHOPLEX® SG-10M Acrylic copolymer emulsion, 50% in water, Tg=28° C. (Rohm & Haas, Philadelphia, Pa.)
Snowflake PE Medium/fine particle size, wet ground marble with a broad particle size distribution (IMERYS, Paris, France)
TAMOL® 1124 Hydrophilic copolymer dispersants, 50% solid (Rohm & Haas, Philadelphia, Pa.)
TERGITOL® NP-9 Nonionic surfactant (Dow, Midland, Mich.)
TEXANOL® ester alcohol Trimethyl hydroxypentyl isobutyrate (Eastman Chemical, Kingsport, Tenn.)
TI-PURE® R-900 Rutile titanium dioxide pigment, 94 wt % minimum titanium dioxide (E.I. du Pont de Nemours & Co., Wilmington, Del.)
TI-PURE® R-902 Rutile titanium dioxide pigment, 91 wt % minimum titanium dioxide (E.I. du Pont de Nemours & Co., Wilmington, Del.)
TRITON® CF-10 Low foam nonionic surfactant (Dow, Midland, Mich.)
TRITON® X-405 Ethoxylated octylphenol nonionic surfactant (Dow, Midland, Mich.)
Tris buffer Tris-(hydroxymethyl)aminomethane
TROYSAN® 785 78.5% aqueous solution of hexahydro-1,3,5-tris-2-hydroxyethyl-s-triazine biocide (Troy Chemicals, Florham Park, N.J.)
UCAR® Latex 379G High molecular weight vinyl-acrylic latex, about 55% total solids by weight (Dow, Midland, Mich.)
UCAR® Filmer IBT Oxygenated solvent (Dow, Midland, Mich.)

### EXAMPLE 1

This example demonstrates the effectiveness of BAE as a biocide synergist.

Each well of a 384 well microtiter plate set up for measuring optical density at 660 nm was filled with 25 μl of an alkylalkanolamine solution (either AMP or BAE) buffered with Tris to pH=7.5, 25 μl of nutrient/innoculum solution at pH=7.5 (nutrient=TSB) and 25 μl of biocide solution adjusted to pH=7.5 for a total volume of 75 μl. The temperature was maintained at 25° C. throughout the experiment. Optical density measurements were made at 15 min intervals. It was established that the microbial concentration was linearly related to optical absorbance in all cases so optical density was used as a direct measurement of microbial density. From optical density measurements, the maximum rate of microbial growth and the 18 hour and 48 hour end point microbial densities could be calculated.

Table 1 shows the end point concentration at 18 hours for Pseudomonas aeruginosa (ATCC 10145) after treatment with various levels of TROYSAN® 785 biocide.

TABLE 1

| Amine | Biocide Concentration | | | | |
|---|---|---|---|---|---|
| (concentration) | 500 ppm | 300 ppm | 200 ppm | 100 ppm | 50 ppm |
| AMP | 0.33 | 0.36 | 0.38 | 0.4 | 0.4 |
| (1000 ppm) | | | | | |
| BAE | 0.12 | 0.18 | 0.22 | 0.23 | 0.23 |
| (1000 ppm) | | | | | |
| AMP | 0.15 | 0.21 | 0.23 | 0.23 | 0.23 |
| (2000 ppm) | | | | | |
| BAE | 0.06 | 0.08 | 0.08 | 0.09 | 0.09 |
| (2000 ppm) | | | | | |

Table 2 shows the maximum growth slope (values given in milli-OD units per minute) (15 point best fit of the linear portion of the growth curve).

TABLE 2

| | Biocide Concentration | | | |
|---|---|---|---|---|
| Amine (concentration) | 500 ppm | 300 ppm | 200 ppm | 100 ppm |
| AMP (1000 ppm) | 0.414 | 0.443 | 0.415 | 0.328 |
| BAE (1000 ppm) | 0 | 0.039 | 0.06 | 0.126 |
| AMP (2000 ppm) | 0.131 | 0.343 | 0.368 | 0.318 |
| BAE (2000 ppm) | 0.093 | 0.113 | 0.105 | 0.098 |

### EXAMPLE 2

This example demonstrates the general applicability of BAE as a neutralizing agent in paint formulations. BAE and AMP were incorporated separately into a high quality flat interior latex paint formulation. The quantities are given in pounds. The paint formulation was: deionized water 150.0; propylene glycol, 25.9; PROXEL® GXL, 0.5; Colloid 226/35, 8.0; TERGITOL® NP-9, 2.2; Colloid 640, 3.5; Polyphobe 102, 15.0; TI-PURE® R-902, 250.0; Snowflake PE, 125.0; MINEX® 4, 125.0; and alkanolamine (either AMP or BAE), 5.0. The resulting mixture was dispersed at high speed then letdown with a mixture containing: UCAR® Latex 379G, 419.8; UCAR® Filmer IBT, 16.8; and Colloid 640, 3.5. The pH was adjusted to 9.0+0.2 and the viscosity to 90±2 KU with: Polyphobe 102, 14.5; alkanolamine, 2.0; and deionized water, 51.3. Total weight: 1218.0 pounds. Total yield: 101.0 gallons. The Pigment Volume Concentration (PVC) for resulting paint formulations is about 40%.

### Evaluation Procedures

The coatings were evaluated using the following ASTM Test Methods: fineness of dispersion, D 1210; viscosity Stormer viscometer D 562; pH, E 70; dry time, D 1640; odor, D 1296; gloss/sheen D 523; opacity, 3-mil drawdown, D 2805; package stability-2 wks at 125° F., D 1849; scrubbability, D 2486; and film porosity.

Color Acceptance The paint was tinted with each tinting colorant at 1% by weight of paint and applied to a sealed chart using a 3-mil Bird applicator. After drying, the relative depth of color was rated in accordance with the ASTM Standardized Scoring Scheme below. The colorants used are Colortrend Universal Colorants, Series 888-1045F Red Iron Oxide, 7214E Thalo Blue, and 2009L Raw Umber.

Color Development Using the same drawdown application as above, as the paint begins to dry; a 1-in area was gently rubbed to redisperse any flocculated colorant. The change in color of the rubbed area verses the unrubbed area was rated in accordance with the ASTM Standardized Scoring Scheme below.

Application Properties Two-thirds of a 24.times.32-Inch Upson Board was primed with one coat of a latex primer and allowed to dry 24 hours. A portion of the primer was tinted a gray color (nominal reflectance of 25) and applied as a 3-inch stripe horizontally across the center of the primed area. After 48 hr drying, the test panel was ready for the application of the test paint.

The paint was applied freely over the entire panel using a 3-in roller (EZ Painter No. 3 FPS) until the gray stripe was obliterated (wet). The spreading rate was calculated from the amount of paint used and the weight per gallon of the paint. After drying overnight, a second coat was applied to one-third of the panel. After fifteen minutes, a 6-in lap coat was applied covering 3-in each of the first coat and second coat areas. The painted panel was allowed to dry overnight before applying a 4.times.4-inch touch-up on the two-coat area.

The paint was also evaluated for: ease of application ; spreading rate; practical opacity; foaming; spatter; leveling; cratering; sheen uniformity; one coat versus two coat area; primed versus unprimed areas; lap area; and touch-up area.

Some observations were subjective and have been rated using the following ASTM Standardized Scoring System in order to avoid lengthy descriptions:

| Score | Performance or | Effect |
|---|---|---|
| 10 | Perfect | None |
| 9 | Excellent | Trace |
| 8 | Very good | Very slight |
| 6 | Good | Slight |
| 4 | Fair | Moderate |
| 2 | Poor | Considerable |
| 1 | Very poor | Severe |
| 0 | No value | Complete failure |

TABLE 3
Evaluation of Flat Interior Latex Paints with Different Neutralizing Agents

| Neutralizing Agent | | AMP | BAE |
|---|---|---|---|
| Fineness of Dispersion | | | |
| Mill base | Hegman | 4 | 4 |
| Grinding time | Minutes | 15 | 15 |
| Final | Hegman | 4 | 4 |
| Viscosity | | KU | |
| Initial | | 93 | 89 |
| After 2 weeks at 125° F. | | 87 | 83 |
| Difference | | −6 | −6 |
| Package Stability | | Score | |
| Settling | | 10 | 10 |
| Ease of redispersion | | 10 | 10 |
| Seeding | | 10 | 10 |
| Dry Time | | Minutes | |
| Set to touch | | 10 | 10 |
| Tack free | | 15 | 17 |
| Dry hard | | 25 | 40 |
| Dry through | | 30 | 45 |
| Gloss - 60° | Units | 8 | 8 |
| Sheen - 85° | Units | 9 | 9 |
| Opacity - 3 mil drawdown | | | |
| Contrast ratio | | 0.967 | 0.964 |
| Odor | Score | Not obnoxious | Not obnoxious |
| Scrubbability | Cycles | 4100 | 4100 |
| Film Porosity Reflectance | | Percent | |
| Before staining | | 91.4 | 94.0 |
| After staining | | 89.9 | 92.5 |
| Difference | | 1.5 | 1.5 |
| Color Acceptance | | Score | |
| Red Iron Oxide | | 10 | 10 |
| Thalo Blue | | 10 | 10 |
| Raw Umber | | 10 | 10 |
| Color Development | | Score | |
| Red Iron Oxide | | 8 | 8 |
| Thalo Blue | | 8 | 8 |
| Raw Umber | | 10 | 10 |
| Application Properties | | | |
| Ease of application | Score | 9 | 9 |
| Foaming | ″ | 10 | 10 |
| Spattering | ″ | 8 | 8 |
| Leveling | ″ | 8 | 8 |
| Cratering | ″ | 10 | 10 |
| Sheen Uniformity | | | |
| One coat versus two coat area | Score | 9 | 9 |
| Primed versus unprimed area | ″ | 10 | 10 |
| Lap area | ″ | 8 | 8 |
| Touch-up area | ″ | 8 | 8 |

### EXAMPLE 3

This Example shows that paint formulations that contain BAE have lower VOCs than paint formulations that contain AMP.

The following paint formulations were prepared as described in Example 2.

TABLE 4
Paint Formulations

| | | | | BAE | AMP |
|---|---|---|---|---|---|
| | % | | | Reduced | Reduced |
| | NVM | AMP | BAE | Solvents | Solvents |
| Deionized Water | | 12.00 | 12.00 | 12.00 | 12.00 |
| Propylene Glycol | | 58.00 | 58.00 | 52.20 | 52.20 |
| TAMOL ® 1124 | 50 | 4.00 | 4.00 | 4.00 | 4.00 |
| AMP | | 1.00 | | | 1.00 |
| BAE | | | 1.00 | 1.00 | |
| FOAMASTER ® | | 1.00 | 1.00 | 1.00 | 1.00 |
| VL | | | | | |
| PROXEL ® GXL | 19.3 | 0.65 | 0.65 | 0.65 | 0.65 |
| TI-PURE ® R-900 | | 268.00 | 268.00 | 268.00 | 268.00 |
| Deionized Water | | 88.00 | 88.00 | 88.00 | 88.00 |
| RHOPLEX ® | 50.5 | 494.00 | 494.00 | 494.00 | 494.00 |
| SG-10M | | | | | |
| TEXANOL ® | | 17.50 | 17.50 | 15.75 | 15.75 |
| TRITON ® X-405 | 70 | 2.10 | 2.10 | 2.10 | 2.10 |
| FOAMASTER ® | 100 | 1.00 | 1.00 | 1.00 | 1.00 |
| VL | | | | | |
| ACRYSOL ® | 20 | 39.50 | 39.50 | 39.50 | 39.50 |
| RM-1020 | | | | | |
| AMP | | 1.00 | | | 1.00 |
| BAE | | | 1.00 | 1.00 | |
| Deionized Water | | 77.50 | 77.50 | 77.50 | 77.55 |
| Total Weight | Pounds | 1065.25 | 1065.25 | 1057.70 | 1057.70 |
| Total Yield | Gallons | 100.1 | 100.1 | 99.2 | 99.2 |

The formulations were evaluated as described in Example 2. Volatile organic content (VOC) was measured by ASTM D39606.

TABLE 5
Evaluation of Latex Paints with Different Neutralizing Agents

| | | | | BAE | AMP |
|---|---|---|---|---|---|
| | | | | Reduced | Reduced |
| | | AMP | BAE | Solvents | Solvents |
| Fineness of | Hegman | 7 | 7 | 7 | 7 |
| Dispersion | | | | | |
| Viscosity | KU | | | | |
| Initial | | 91 | 87 | 91 | 90 |
| After 2 weeks at | | 100 | 97 | 100 | 100 |
| 125° F. | | | | | |
| Change | | 9 | 10 | 9 | 10 |
| pH | | | | | |
| Initial | | 8.8 | 8.7 | 8.6 | 8.7 |
| After 2 weeks at | | 8.4 | 8.3 | 8.3 | 8.4 |
| 125° F. | | | | | |
| Change | | 0.4 | 0.4 | 0.3 | 0.3 |
| Volatile Organic | | | | | |
| Content (VOC) | | | | | |
| gm/l | | 210 | 204 | 191 | 202 |
| lb/gal | | 1.8 | 1.7 | 1.6 | 1.7 |
| Package Stability - 2 | | | | | |
| weeks at 125° F. | | | | | |
| Syneresis | Score | 10 | 10 | 10 | 10 |
| Settling | ″ | 10 | 10 | 10 | 10 |
| Ease of | ″ | 10 | 10 | 10 | 10 |
| Redispersion | | | | | |
| Seeding | ″ | 10 | 10 | 10 | 10 |
| Dry Time | | | | | |
| Set to Touch | Minutes | 15 | 15 | 15 | 15 |
| Tack Free | Hours | 3.75 | 3.75 | 3.75 | 3.75 |
| Dry Hard | ″ | ″ | ″ | ″ | ″ |
| Dry Through | ″ | ″ | ″ | ″ | ″ |
| Gloss - 60° | Units | 76 | 76 | 77 | 74 |
| Hiding | Percent | 97.6 | 97.5 | 97.5 | 97.2 |
| Scrub Resistance | Cycles | 1625 | 1525 | 1655 | 1475 |
| Color Acceptance | | | | | |
| and Color | | | | | |
| Development | | | | | |
| Red Iron Oxide | Score | 10 | 10 | 10 | 10 |
| Thalo Blue | ″ | 10 | 10 | 10 | 10 |
| Raw Umber | ″ | 10 | 10 | 10 | 10 |

### EXAMPLE 4

This example demonstrates that BAE is a better pigment dispersant than AMP.

AMP and BAE were incorporated separately into a semi-gloss latex paint formulation, except that the amount of anionic pigment dispersant typically used (BYK®-156) was reduced from 6.00 pounds per 100 gallons to 2.00 pounds per 100 gallons and the amount of alkanolamine (either AMP or BAE) was increased from 4.00 pounds per 100 gallons to 6.00 pounds per 100 gallons.

The quantities are given in pounds. The paint formulation was: deionized water 34.33; propylene glycol, 34.55; BYK®-1650, 1.00; alkanolamine (either AMP or BAE), 6.00; BYK®-156, 2.00; TRITON® CF-10, 2.00; TI-PURE® R-900, 253.50; and MINEX® 4, 24.94.

The resulting mixture was dispersed at high speed then letdown with a mixture containing: UCAR® 481, 562.35; TEXANOL® ester alcohol, 15.75; propylene glycol, 8.64; BYK®-1650, 1.00; ACRYSOL® RM-8, 35.95; and deionized water, 83.33. The resulting paint formulations have a Pigment Volume Concentration (PVC) of 23.024% and a total volume of about 100 gallons.

Next, additional titanium dioxide pigment was added to each paint formulation while grinding. Pigment was added until the grind temperature increased to 50° C and the other observable properties of the grind (noise, paste consistency) indicated that too much pigment had been added. An additional 260 grams of pigment could be added to the paint formulation containing AMP, while an additional 606 grams of pigment could be added to the paint containing BAE.

### EXAMPLE 5

This example demonstrates that BAE is a better pigment dispersant than AMP.

The paint formulation of Example 4 was prepared, except that the formulation contained 4.00 pounds per 100 gallons of the alkanolamine (either AMP or BAE), and no BYK®-156 pigment dispersant was present. The amount of additional alkanolamine needed to produce a paint formulation equivalent to one that contained 6.00 pounds per gallon of BYK®-156 pigment dispersant determined. For AMP, 10.27 pounds per hundred gallons of paint formulation was required. For BAE, only 5.74 pounds per hundred gallons of paint formulation was required.

The resulting paint formulations were then evaluated for water sensitivity, gloss, and color acceptance as described in Example 2. They were compared with a standard paint formulation, which contains 4.00 pounds per 100 gallons of AMP and 6.00 pound per gallon of BYK®-156 pigment dispersant. The results are given in Tables 6-8.

TABLE 6
Water Sensitivity

| Paint Formulation | Rating |
|---|---|
| Standard paint | 3 |
| Excess AMP | 1 |
| Excess BAE | 10 |

TABLE 7
Gloss

| Paint Formulation | 20° Gloss | 60° Gloss | 85° Gloss |
|---|---|---|---|
| Standard paint | 13.5 | 50.6 | 64.1 |
| Excess AMP | 14.9 | 49.9 | 66.1 |
| Excess BAE | 16.9 | 54.3 | 63.6 |

TABLE 8
Color Acceptance

| Paint Formulation | Red Iron Oxide | Phthallo Blue | Raw Umber |
|---|---|---|---|
| Standard paint | 10 | 10 | 10 |
| Excess AMP | 10 | 10 | 10 |
| Excess BAE | 10 | 10 | 10 |

Having described the invention, we now claim the following and their equivalents.

What is claimed:

1. A latex paint formulation comprising:
a) one of more binders;
b) one or more pigments;
c) water; and
d) N-n-butyl ethanolamine;
in which the pigment volume concentration of the formulation is 38% to 80%.

2. The latex paint formulation of claim 1 in which the formulation comprises two to ten pounds of the N-n-butyl ethanolamine per one hundred gallons of the formulation.

3. The latex paint formulation of claim 1 in which the binder is a vinyl-acrylic resin.

4. The latex paint formulation of claim 1 in which the binder is a 100% acrylic resins.

5. The latex paint formulation of claim 1 in which the pigment volume concentration of the formulation is 38% to 50%.

6. The latex paint formulation of claim 5 in which the formulation comprises two to ten pounds of the N-n-butyl ethanolamine per one hundred gallons of the formulation.

7. The latex paint formulation of claim 6 in which the formulation additionally comprises a co-solvent.

8. The latex paint formulation of claim 7 in which the formulation additionally comprises one or more additives selected from the group consisting of leveling agents, rheology modifiers, corrosion inhibitors, biocides, mildewcides, and defoamers.

9. The latex paint formulation of claim 7 in which the formulation additionally comprises a biocide.

10. The latex paint formulation of claim 6 in which the binder is a vinyl-acrylic resin.

11. The latex paint formulation of claim 6 in which the binder is a 100% acrylic resins.

12. The latex paint formulation of claim 1 in which the formulation additionally comprises a biocide.

13. The latex paint formulation of claim 1 in which the formulation additionally comprises a co-solvent.

14. The latex paint formulation of claim 13 in which the formulation additionally comprises one or more additives selected from the group consisting of leveling agents, rheology modifiers, corrosion inhibitors, biocides, mildewcides, and defoamers.

15. A method comprising applying a latex paint formulation to a substrate, in which the latex paint formulation comprises: one of more binders, one or more pigments, one or more a co-solvents, one or more biocides, N-n-butyl ethanolamine, and water; in which the pigment volume concentration of the formulation is 38% to 80%.

16. The method of claim 15 in which the formulation comprises two to ten pounds of the N-n-butyl ethanolamine per one hundred gallons of the formulation.

17. The method of clam 16 in which the pigment volume concentration of the formulation is 38% to 50%.
